(19) United States
(12) Patent Application Publication
(10) Pub. No.: US 2018/0101233 A1
(43) Pub. Date: Apr. 12, 2018

(54) APPARATUS, SYSTEMS, AND METHOD FOR SIMULATING A PHYSICAL KEYBOARD

(71) Applicant: LENOVO (Singapore) PTE. LTD., New Tech Park (SG)

(72) Inventors: Yasushi Tsukamoto, Yokohama-shi (JP); Fusanobu Nakamura, Yokohama-shi (JP); Mitsuhiro Yamazaki, Yokohama-shi (JP); ZhePeng Wang, Beijing (CN)

(21) Appl. No.: 15/782,439

(22) Filed: Oct. 12, 2017

(30) Foreign Application Priority Data
Oct. 12, 2016 (JP) 2016-200870

(51) Int. Cl. G06F 3/01; G06F 3/041; G06F 3/0488; G06F 3/16

(52) U.S. Cl. CPC G06F 3/016; G06F 3/16; G06F 3/04886; G06F 3/0416

(57) ABSTRACT

Apparatus, systems, methods, and computer program products for simulating a physical keyboard are disclosed. One apparatus includes a processor for an information handling device and a memory that stores code executable by the processor. The code is executable by the processor to detect an input mechanism contacting a key area for displaying a flat keyboard and emit a first sensory feedback to a user in response to detecting the input mechanism contacting the key.

### CROSS-REFERENCE TO RELATED APPLICATIONS

This patent application claims priority to Japan Patent Application No. JP2016-200870, filed on 12 Oct. 2016 for Yamazaki, et al., the entire contents of which are incorporated herein by reference for all purposes.

### FIELD

The present disclosure relates to information processing devices, apparatus, systems, methods, and computer program products for simulating a physical keyboard, and especially, by a flat and/or virtual keyboard.

### BACKGROUND OF THE INVENTION

In recent years, a flat and smooth keyboard (hereinafter, referred to as a “flat keyboard” or “virtual keyboard”) has been developed in which an image of a keyboard is displayed on a panel equipped with a touch sensor. The flat keyboard some advantages including reducing the thickness and weight of a device, an aesthetically pleasing quality, ease of cleaning, and the like, when compared to conventional physical keyboards (e.g., hardware keyboards).

The keys of a flat keyboard, however, do not have a top surface (e.g., key tops) like the keys of a physical keyboard because the surface of the flat keyboard is planar. Key inputs on a flat keyboard (e.g., typing) do not generate any keystrokes and/or repulsive forces from the flat keyboard because of the input surface is flat. Therefore, a user has less sense of touch and/or tactile response when typing on a flat keyboard compared to a conventional keyboard.

### SUMMARY OF THE INVENTION

Various embodiments provide apparatus and systems for a flat or virtual keyboard simulating a physical keyboard. Further embodiments provide methods and computer program products related to such apparatus and systems.

In one embodiment, a user detection apparatus includes a processor for an information handling device and a memory that stores code executable by the processor. The code is executable by the processor to detect an input mechanism contacting a key area for displaying a flat keyboard and emit a first sensory feedback to a user in response to detecting the input mechanism contacting the key.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic external view of one embodiment of a laptop personal computer (PC) including a chassis;

FIG. 2 is a vertical cross-sectional view of an embodiment of the chassis of FIG. 1 including a flat keyboard;

FIG. 3 is an example functional block diagram for the laptop PC of FIG. 1;

FIG. 4 is an example functional block diagram showing one embodiment of tactile feedback; and

FIG. 5 is a flowchart illustrating one embodiment of a method for processing user feedback.

### DETAILED DESCRIPTION OF THE INVENTION

Embodiments of information processing devices, apparatus, and systems for simulating a physical keyboard, and especially, by a flat and/or virtual keyboard, are described with reference to the drawings. Also described are embodiments of methods and computer program products that can simulate a physical keyboard.

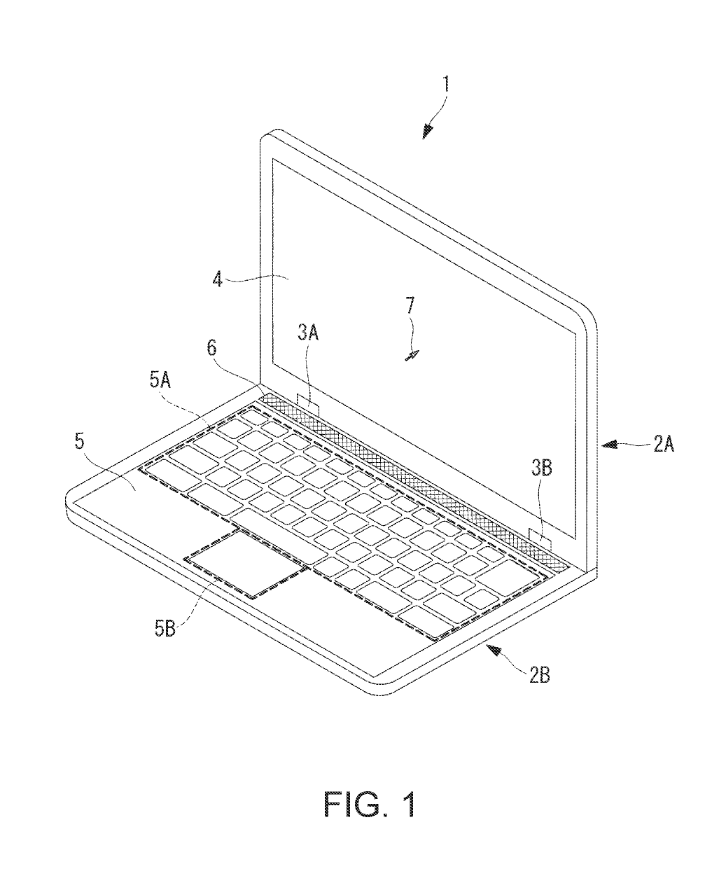

FIG. 1 is a schematic external view of one embodiment of a laptop personal computer (PC) 1. At least in the illustrated embodiment, a laptop PC 1 includes, among other components, a first chassis 2A and a second chassis 2B.

The first chassis 2A and the second chassis 2B may include any suitable shape that is known or developed in the future that can facilitate and/or implement a touch panel display 4, a flat keyboard 5, and/or a loudspeaker 6. In some embodiments, the first chassis 2A and/or the second chassis 2B includes a substantially rectangular shape, among other shapes that are possible and contemplated herein. In additional or alternative embodiments, the first chassis 2A and the second chassis 2B may include the same or different shapes.

The first chassis 2A and the second chassis 2B are connected and/or coupled to each other via a pair of right and left connecting portions 3A and 3B located at the respective ends thereof, among other locations that are possible and contemplated herein.

The connecting portions 3A and 3B may include any suitable type of connecting/coupling mechanism or device that is known or developed in the future that can support and/or facilitate opening/closing the first chassis 2A and the second chassis 2B. In some embodiments, the connecting portions 3A and 3B include hinges, among other types of connecting/coupling mechanisms or devices that are possible and contemplated herein.

As shown in FIG. 1, the first chassis 2A includes a touch panel display 4 and the second chassis 2B includes a flat keyboard 5 and a loudspeaker 6. In other embodiments, the first chassis 2A includes a flat keyboard 5 and a loudspeaker 6 and the second chassis 2B includes a touch panel display 4. Other configurations of a first chassis 2A, a second chassis 2B, a touch panel display 4, a flat keyboard 5, and/or a loudspeaker 6 are possible and contemplated herein.

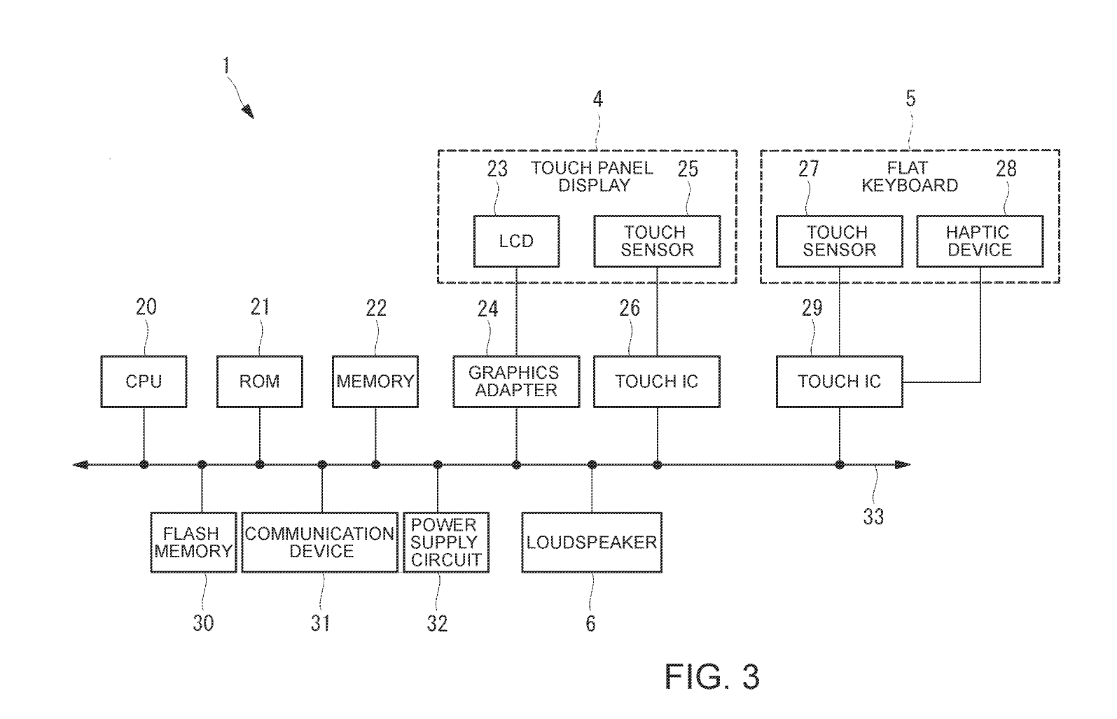

A touch panel display 4 may include any type of display that is known or developed in the future. As shown, the touch panel display 4 includes a liquid crystal display (LCD) 23 including a display screen and a touch sensor 25 (see e.g., FIG. 3). The touch panel display 4 can display various kinds of data and/or information corresponding to display data converted to a video signal on a display screen. Further, the touch panel display 4 can detect contact with an indicator or input mechanism, such as, for example, the finger(s) of a user, a stylus, and/or a pen and/or the proximity of the indicator by a touch sensor that is configured to and capable of accepting/receiving an operation input by the indicator. Notably, contact or proximity of a user's finger(s) to the LCD 23 or the flat keyboard 5 can simply be referred to as a “touch” in the following description.

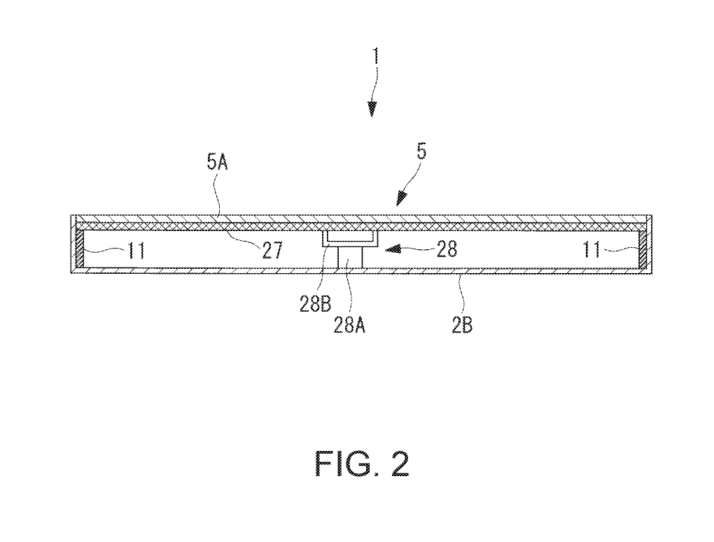

A flat keyboard 5 may be any type of flat keyboard that is known or developed in the future. In some embodiments, a flat keyboard 5 includes a flat and smooth keyboard in which an image of the keyboard can be displayed and/or printed on a panel equipped with a touch sensor 27 (see e.g., FIGS. 2 and 3). In additional or alternative embodiments, a flat keyboard 5 includes may lack a keystroke and/or provide a small keystroke, if any.

A flat keyboard 5 may include an area with any suitable size and/or components included thereon. In some embodiments, a flat keyboard 5 includes a key area 5A and a touch pad area 5B, among other components that are possible and contemplated herein.

In various embodiments, a key area 5A may include a keyboard area for accepting key input, among other types of area that are possible and contemplated herein. An image indicating a plurality of key positions for accepting characters, commands, and/or the like may be displayed in the key area 5A, among other types of indicators and/or positions that are possible and contemplated herein. As shown, the keys include a plurality of character keys for accepting character inputs (e.g., alphanumeric inputs) and/or a plurality of function keys for accepting functions other than and/or in addition to the character inputs, among other types of inputs that are possible and contemplated herein.

A touch pad area 5B, in various embodiments, may include an area for performing a pointing operation that can move a pointer 7 displayed on the touch panel display 4 and/or perform a tapping operation. Although the touch pad area 5B illustrated in FIG. 1 is displayed as including a rectangular shape, the shape is not limited thereto, but may be any other suitable shape. Further, although the touch pad area 5B is illustrated on the bottom side (e.g., the user side) of the key area 5A, the position is not limited thereto. For example, the touch pad area 5B may be provided to the right or left of the key area 5A or may be provided in the center or substantially in the center of the key area 5A with a button-like shape (also referred to as “pointing stick”), among other locations and/or shapes that are possible and contemplated herein. In some embodiments, a flat keyboard 5 is devoid of the touch pad area 5B.

With reference to FIG. 2, FIG. 2 is a vertical cross-sectional view of one embodiment of a second chassis 2B including a flat keyboard 5. At least in the illustrated embodiment, a second chassis 2B includes, among other components, a haptic device 28 on the back of the key area 5A and the touch sensor 27. As further illustrated in FIG. 2, a second chassis 2B can include a rectangular frame 11 enclosing the area surrounding the flat keyboard 5, a frame 11, various bases (not illustrated), and/or the like on the inside of the second chassis 2B.

A haptic device 28 can include a feedback unit that provides and/or emits feedback to a user's finger tactile sense (hereinafter, referred to as “haptic feedback” or “tactile feedback”). In some embodiments, a haptic device 28 can be equipped with an actuator 28A that generates, for example, a vibration, among other types of haptic feedback that are possible and contemplated herein.

An actuator 28A according to some embodiments can transmit a vibration to the flat keyboard 5 based on the key input(s) performed by a user on the flat keyboard 5. In some embodiments, an actuator 28A can provide a user with the illusion of actually having pressed the key (e.g., the feel and/or tactile sensation of pressing and/or releasing a key). For example, a user can perceive a vibration to the user's finger and/or a sound/noise (e.g., a sound/noise resembling the keystroke of a physical keyboard) produced by the actuator 28A as being a keystroke performed on a conventional keyboard.

In some embodiments, the actuator 28A can provide and/or emit a vibration with a certain amplitude and/or pitch to a vibrator 28B for a predetermined period of time, which can be any suitable amount of time that can produce a vibration that can be perceived by a user as being and/or resembling the keystroke of a conventional keyboard. For example, the actuator 28A may be an eccentric rotating mass (ERM) actuator with an eccentric motor, a linear resonant actuator (LRA) that vibrates a mover by passing alternating current through a coil in the magnetic field, an actuator using shape memory alloy (e.g., a shape memory alloy impact actuator [SIA]), and/or an actuator using a piezoelectric element (e.g., a piezo element, a piezo vibration actuator [PVA], etc.), etc., among other types of actuators that are possible and contemplated herein.

Although FIG. 2 illustrates one haptic device 28 provided in substantially the center of the second chassis 2B, the various embodiments are not limited to one haptic device 28 and/or location of the haptic device(s) 28. That is, other embodiments can include more than one haptic device 28. For example, multiple haptic devices 28 may be provided at one or more of the four corners, a haptic device 28 may be located at two or more corners, multiple haptic devices 28 may be provided at one or more locations, and/or one or more haptic devices 28 may be provided at two or more different locations inside the second chassis 2B.

In some embodiments, a haptic device 28 may be provided on the frame 11 of the second chassis 2B, instead of or in addition to inside the second chassis 2B. In embodiments in which the haptic device(s) 28 is/are provided on the frame 11, the haptic device(s) 28 is/are provided, for example, one by one on opposite sides of the second chassis 2B and/or one by one on four sides.

A loudspeaker 6 may be located in any suitable position and/or location that can project audible signals. As shown, the loudspeaker 6 is provided proximate the key area 5A, among other positions and/or locations that are possible and contemplated herein. In the example illustrated in FIG. 1, the loudspeaker 6 is provided on the upper side (e.g., on the touch panel display 4 side) of the key area 5A among other positions and/or locations that are possible and contemplated herein. The position is not limited thereto, but the loudspeaker 6 may be provided at any suitable position and/or location within the key area 5A. In addition, the loudspeaker 6 may be provided on the back of the key area 5A, for example, provided that it is positioned/located on/in the second chassis 2B.

FIG. 3 is an example functional block diagram of the laptop PC 1. In addition to the touch panel display 4, the flat keyboard 5, and the loudspeaker 6, the laptop PC 1, in various embodiments, can include a central processing unit (CPU) 20, a read only memory (ROM) 21, a memory 22, a graphics adapter 24, a touch integrated circuit (IC) 26, a touch IC 29, a flash memory 30, a communication device 31, and/or a power supply circuit 32, etc., directly or indirectly connected to and in communication with each other via a bus 33 (e.g., a wired and/or wireless bus), among other components that are possible and contemplated herein.

As described elsewhere herein, a touch panel display 4 can include a LCD 23 and a touch sensor 25. Moreover, a flat keyboard 5 can include a touch sensor 27 and a haptic device 28.

A CPU 20 can include functionality to control the laptop PC 1 using an operating system (OS) stored in a flash memory 30. The CPU 20 can further perform processing operations corresponding to user inputs received via the touch panel display 4, the flat keyboard 5, and/or the like input devices based on various programs stored in the flash memory 30.

The ROM 21 can store basic input/output system (BIOS) operations, various data, and/or the like computer-useable code/instructions. A memory 22 can include a cache memory and a random access memory (RAM) and is a writable memory that is used as a work area for reading an execution program of the CPU 20 and writing processing data by the execution program.

An LCD 23 can display a video signal from the graphics adapter 24 as an image according to the control of the CPU 20. The graphics adapter 24 can convert display information to a video signal corresponding to the control operations of the CPU 20 and output the converted video signal to the LCD 23.

A touch sensor 25 can detect a physical quantity indicating a contact state of an input mechanism (e.g., a user's finger, a stylus, a pen, and/or the like) with the LCD 23. In response to physical contact, the touch sensor 25 can output the detected physical quantity and/or contact position of the input mechanism, user's finger, stylus, pen, etc., which is transmitted as detection signals to the touch IC 26.

A touch IC 26 can perform various types of processing based on detection signals input from the touch sensor 25 by the execution of programs stored in the ROM 21 and/or the like executed by the processor. The touch IC 26 can further control the operations of the touch sensor 25.

A touch sensor 27 can detect the physical quantity indicating the contact state of the input mechanism, user's finger, stylus, pen, etc., to the key area 5A and/or the touch pad area 5B provided in the flat keyboard 5. In response thereto, the touch sensor 27 can output the detection signals to a touch IC 29.

The touch sensors 25 and 27 according to various embodiments can be, for example, pressure sensors, among other types of sensors that can detect physical contact that are possible and contemplated herein. In the following description, the physical quantities detected by the touch sensors 25 and/or 27 are pressure quantities, although other physical quantities are possible and contemplated herein. In response to detecting pressure, the touch sensors 25 and 27 can output the contact position and/or the pressure value as detection signals to the touch IC 26 and/or touch IC 29.

A touch IC 29 can perform various types of processing based on detection signals input from the touch sensor 25 by the execution of programs stored in the ROM 21 or the like by the processor. The touch IC 29 can further control the operations of the touch sensor 27, which are discussed elsewhere herein.

A flash memory 30 can store an OS for controlling the laptop PC 1, various drivers for performing hardware operations of peripherals and/or the like hardware and/or software devices, one or more applications for performing specific and/or general tasks, and/or various data or files, etc., among other computer-useable code that is possible and contemplated herein.

The laptop PC 1 may include one or more other types of suitable storage mediums that are known or developed in the future. For example, a hard disk drive (HDD) may be included in addition to or instead of the flash memory 30, among other types of storage/memory devices that are possible and contemplated herein.

A communication device 31 can be any suitable hardware and/or software that can facilitate communication with one or more other devices. A power supply circuit 32 can be any suitable type of hardware and/or software that can generate and/or supply power to one or more devices according to the control of the CPU 20. Non-limiting examples of a power supply circuit 32 include, but are not limited to, an AC adapter, a battery, a charger for charging the battery, and/or a DC-DC converter, etc., among other types of devices that can supply electric power.

The following example operations are for the purpose of understanding the principles of the various embodiments are not to limit the various embodiments in any manner. When a user performs key input, the flat keyboard 5 according to various embodiments can provide haptic feedback that vibrates a haptic device 28 or generate sound from the loudspeaker 6 (hereinafter, collectively referred to as “user feedback”) to resemble a conventional keyboard. In this manner, the various embodiments of a flat keyboard can imitate a conventional keyboard.

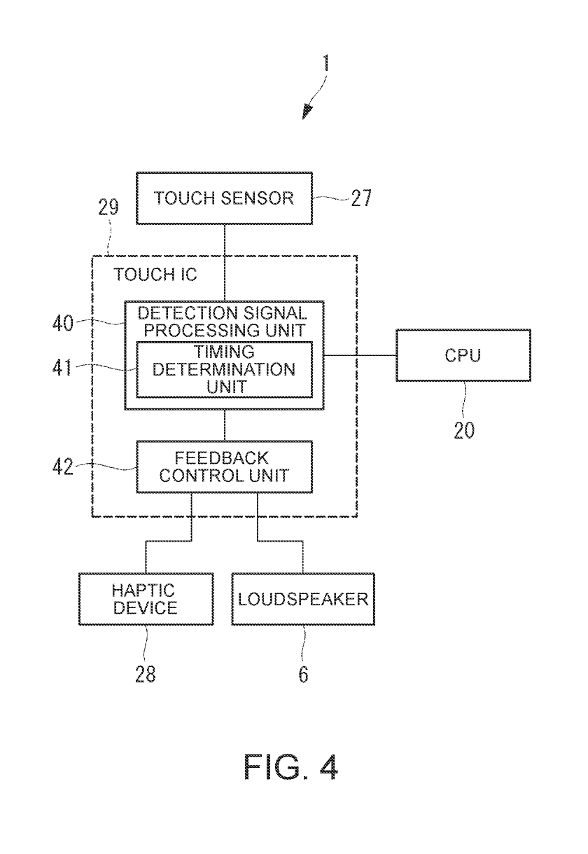

FIG. 4 is an example functional block diagram related to user feedback according to various embodiments. A touch IC 29 can include a detection signal processing unit 40 and a feedback control unit 42.

A detection signal processing unit 40 can output a key position indicated by a detection signal from the touch sensor 27 to the CPU 20. In addition, the detection signal processing unit 40 can include a timing determination unit 41.

A timing determination unit 41 can determine the input start timing, which is a time when a user's finger touches the key area 5A (e.g., a “Make”). A timing determination unit 41 can further determine the input end timing, which is a time when the user's finger moves away from the key area 5A (e.g., a “Break”) on the basis of a pressure value detected by the touch sensor 27. Specifically, the timing determination unit 41 can determine when an initial pressure value detected by the touch sensor 27 is greater than or equal to a first threshold value and a subsequent pressure value is less than or equal to a second threshold value after the initial pressure value is detected. In other words, a timing determination unit 41 can detect when the user presses a key at a key position with a force above a certain level that is greater than or equal to the first threshold value to signal the beginning of a user using the key area 5A. Therefore, the timing when the detected pressure is greater than or equal to the first threshold value can be the input start timing.

On the other hand, when the input ends, the force applied to the key at the key position is reduced or zero. Therefore, the timing when the detected pressure is smaller than or equal to the second threshold value can be the input end timing. For the first threshold value and the second threshold value, various values can be set based on the size, shape, material, and/or primary usage pattern, etc., of the flat keyboard 5 or the information processing device (laptop PC 1) to which the present invention is applied, among other metrics that are possible and contemplated herein. The first threshold value and the second threshold value may be the same or different values, with either of the threshold values being set to the larger value. Furthermore, since the pressing force can be different with each user, the pressure values of past uses for each user may be recorded and stored so that the initially set pressure value can be automatically corrected and/or set on the basis of one or more past pressure values. In one embodiment, for example, 60 gf can be preset as the first threshold value and 50 gf can be preset as the second threshold value, among other values and/or units of measurement that are possible and contemplated herein.

A feedback control unit 42 can operate the haptic device 28 at the input start timing and/or operate the loudspeaker 6 at the input end timing. Specifically, the loudspeaker 6 can function as a feedback unit that provides feedback to a user's auditory sense (e.g., the pressing and/or releasing sound of a key).

A loudspeaker 6 can generate and/or emit a sound simulated from a sound generated when a key input is performed (hereinafter, referred to as “keying sound”) at the input end timing. The frequency, length, volume, and/or the like of a keying sound can be suitably adjusted to imitate and/or simulate a sound generated when key input is performed on a conventional/physical keyboard (e.g., pressing and/or releasing a key). In addition, the keying sound may be, for example, a sound simulated from a sound generated when an actuator 28A forming at least a portion of and/or including a haptic device 28 operates. Furthermore, the keying sound may be a sound obtained by recording an actual sound generated when a key input is performed on a conventional/physical keyboard. The generation and/or emission of a keying sound simulated from a sound generated at the time of key input, as described herein, can assist in giving a user the illusion of having operated a conventional/physical keyboard. In other words, the illusion that an actual physical key and/or conventional key has been pressed.

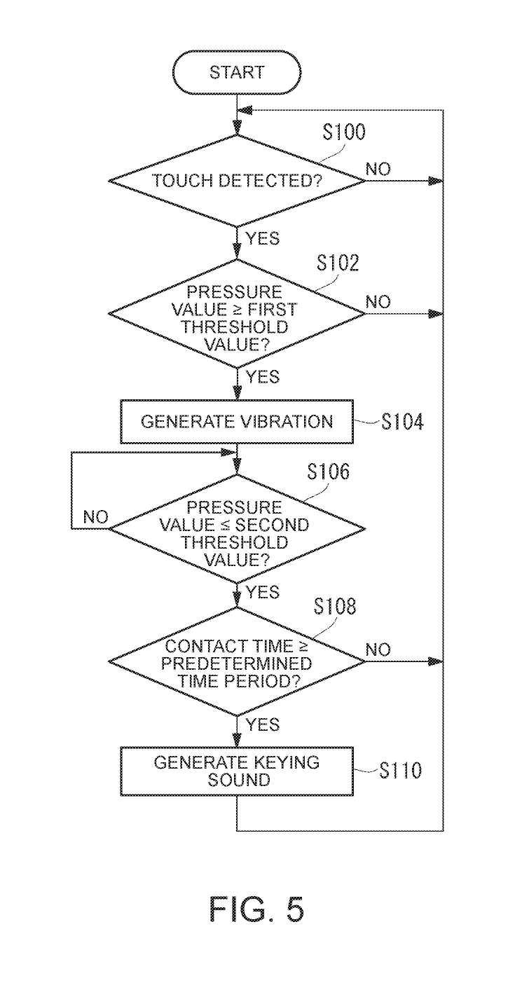

FIG. 5 is a flowchart illustrating one embodiment of a method for processing user feedback. At least in the illustrated embodiment, the method begins, in block S100, the detection signal processing unit 40 determining whether the touch sensor 27 has detected a touch to the key area 5A.

In response to determining a touch (e.g., a “YES” in block S100), the method proceeds to block S102. In block S102, the detection signal processing unit 40 determines whether the touch sensor 27 has detected the touch to the key area 5A based on the presence and/or absence of an input of a detection signal from the touch sensor 27. Further in block S102, the timing determination unit 41 can determine whether the pressure value detected by the touch sensor 27 is greater than or equal to the first threshold value. In response to not detecting a touch (e.g., a “NO” in block S100), the method returns to block S100 and/or continues in block S100.

In response to the detected pressure value being greater than or equal to the first threshold value (e.g., a “YES” in block S102), the method proceeds to block S104. Specifically, the timing at which the affirmative determination can be considered an input start time. On the other hand, in response to the detected pressure value being less than the first threshold value (e.g., a “NO” in block S102), the detected touch is not intended for key input and the method returns to block S100.

In block S104, the feedback control unit 42 can operate the haptic device 28 (e.g., actuator 28A) so that the haptic device 28 vibrates. The time period during which the haptic device 28 vibrates can be any amount of time or period of time that is appropriate for providing feedback to the user (e.g., about 20 ms, among other amounts of time that are greater than or less than about 20 ms that are possible and contemplated herein).

In block S106, the timing determination unit 41 can determine whether the pressure value detected by the touch sensor 27 is less than or equal to a second threshold value. In response to the detected pressure value being less than or equal to the second threshold value (e.g., a “YES” in block S106), the method proceeds to step S108. Specifically, the timing at which the affirmative determination is made can be considered an input end time. In response to the detected pressure value being greater than the second threshold value (e.g., a “NO” in block S106), the touching finger remains on the key position (or is not away from the key position) and the determination of block S106 is repeated until the pressure value becomes less than or equal to the second threshold value.

The feedback control unit 42, in block S108, can determine whether the time period during which the user's finger is in continual or substantially continual contact with the key position (hereinafter, the time period is referred to as “contact time”), is greater than or equal to a predetermined amount of time or period of time (e.g., 20 ms, among other amounts of time that are possible and contemplated herein). The feedback control unit 42 can calculate a time interval between the input start time and the input end time, as a contact time.

In response to the contact time being greater than or equal to the predetermined amount of time (e.g., a “YES” in block S108), the method proceeds to block S110. In response to the contact time being less than the predetermined amount of time (e.g., a “NO” in block S108), the method returns to block S100.

In block S110, the feedback control unit 42 can operate the loudspeaker 6 to generate a keying sound. The method then returns to block S100.

In this manner, the flat keyboard 5 can provide tactile feedback with vibration at the input start time for a user that performs key inputs. The flat keyboard 5 can further provide tactile feedback with a keying sound at the input end time for a user that performs key inputs. The user can feel vibration(s) from the key position at the timing of pressing the key and can also hear the keying sound at the timing of moving the finger away from the pressed key, which can give the user the illusion that an actual physical key has been pressed and/or enable the user to type the flat keyboard 5 as though the user is typing on an actual physical keyboard. Accordingly, the various embodiments can enable and/or provide more favorable tactile feedback for a user who performs key inputs on a flat keyboard 5.

Moreover, a flat keyboard 5 can generate haptic feedback at the input start time and can further generate a keying sound from a loudspeaker 6 at the input end time to provide a user, via haptic feedback, with the sensation of actually pressing and releasing keys of a physical keyboard. As such, a flat keyboard 5 can reduce power consumption and/or provide feedback without impairing the operational feeling of a user performing key inputs compared to generating vibrations with the haptic device 28 twice.

Furthermore, a loudspeaker 6 may be provided proximate and/or inside the key area 5A so that the user senses that the keying sound were generated from the key area 5A. Accordingly, the flat keyboard 5 can provide favorable tactile feedback to a user using the laptop PC 1.

In addition, the feedback control unit 42 may not operate the loudspeaker 6 if the contact time of a user's finger is less than or equal to a predetermined amount of time. In other words, the feedback with the keying sound may be omitted and/or optional. A contact time that is less than or equal to the predetermined time period can indicate that a user is performing key inputs at high rate of speed. In such a case, the user may be able to type on the flat keyboard 5 as though the user were typing on a physical keyboard without receiving feedback with a keying sound.

Although tactile feedback with vibration and tactile feedback with a keying sound have been performed at the input start time and/or at the input end time, respectively, in various embodiments, the timing of feedback with the keying sound is not limited thereto. That is, the tactile feedback with vibration may be performed at the input start time and/or at the input end time. Likewise, the tactile feedback with a keying sound may be performed at the input start time and/or at the input end time, without or without the vibration tactile feedback.

For example, the tactile feedback with keying sound from the loudspeaker 6 may be performed at the input start time and the tactile feedback with vibration of the haptic device 28 may be performed at the input end time. Alternatively, both the tactile feedback with vibration and the tactile feedback with the keying sound from the loudspeaker 6 may be performed at the input start time and then the feedback with keying sound may be performed at the input end time, or the tactile feedback with keying sound from the loudspeaker 6 may be performed at the input start time and then both of the tactile feedback with vibration of the haptic device 28 and the tactile feedback with the keying sound from the loudspeaker 6 may be performed at the input end time. Further, the tactile feedback with keying sound from the loudspeaker 6 and the tactile feedback with vibration of the haptic device 28 may be performed at both the input start time and the input end time.

In addition, based on a user's settings, the operation of the tactile feedback with vibration of the haptic device 28 and/or the tactile feedback with keying sound from the loudspeaker 6 may be omitted. For example, omission may be based on a charging rate and/or level of charge of a battery and/or other power source, among other metrics and/or devices that are possible and contemplated herein.

As described elsewhere herein, a flat keyboard 5 according to various embodiments can control a haptic device 28 and/or a loudspeaker 6 based on whether the timing is an input start time or an input end time. That is, a flat keyboard 5 according to some embodiments can provide and/or emit a favorable/pleasing tactile feedback to a user of the laptop PC 1.

In addition, the magnitude of vibration of a haptic device 28 and/or the volume of the keying sound from a loudspeaker 6 may be adjustable. For example, a user can set and/or modify the magnitude of the vibration(s) and/or the volume of a keying sound, which may be based on a user's preference. The magnitude of the vibration(s) and/or the volume of a keying sound may be set/modified by increasing the magnitude of vibration while decreasing the volume of keying sound, decreasing the magnitude of vibration while increasing the volume of the keying sound, or increasing/decreasing both the magnitude of vibration and the volume of keying sound.

Although various embodiments have been described herein, the technical scope of the various embodiments are not limited to the scope specifically described above. That is, various modifications and/or improvements may be made to the various embodiments without departing from the spirit of this disclosure. As such, embodiments in which modifications and/or improvements have been made are also included in the technical scope of the various embodiments.

For example, although the mode in which the laptop PC 1 includes the flat keyboard 5 has been described in the above embodiments, the laptop PC 1 and flat keyboard 5 are not limited thereto. That is, a flat keyboard 5 may be an external keyboard connectable to an information processing device (e.g., a desktop PC, a tablet-type portable terminal, a cellular telephone, a personal digital assistant (PDA), etc.) via a universal serial bus (USB) or the like. Moreover, a flat keyboard 5 according to various embodiments may be a software keyboard (also referred to as “screen keyboard”). In the case of a screen keyboard, a touch sensor 25 may be provided on the back of an LCD 23 and a haptic device 28 may be provided on the back of the touch sensor 25.

Furthermore, although the mode/modes in which a haptic device 28 including and/or forming at least a portion of an actuator 28A that generates vibrations has been described in the above embodiments, the mode/modes is/are not limited thereto. For example, the actuator 28A may generate a repulsive force (e.g., a shock) instead of a vibration. As to an actuator 28A that generates a repulsive force, the actuator 28A, as a vibration element, can hit the vibrator 28B to apply a transient vibration. The actuator 28A may include a shape memory metal impact actuator (SIA) using shape memory alloy and/or a piezo vibration actuator (PVA) with a piezoelectric element (e.g., a piezo element). In addition, a haptic device 28 may be configured to exert an electrical stimulation to a finger using an electric current and/or voltage instead of using the actuator 28A.

Furthermore, although the mode/modes in which a touch sensor 27 is a pressure sensor has been described in the above embodiments, the various embodiments are not limited thereto. That is, a touch sensor 27 may be any other type of sensor that can detect physical contact including, for example, a capacitive sensor, among other types of sensors that are possible and contemplated herein.

For a touch sensor 27 that is and/or forms at least a portion of a capacitive sensor, the contact areas may include electrical fields. Further, instead of the above first and second threshold values being pressure values, the first and second threshold values may be capacitive values, resistance values, and/or current values, etc., among other electrical values that are possible and contemplated herein.

In addition, although the mode/modes in which the detection signal processing unit 40 and/or the feedback control unit 42 are provided in the touch IC 29 has been described in the above embodiments, the various embodiments are not limited thereto. That is, a detection signal processing unit 40 and/or a feedback control unit 42 may be provided in any other suitable type of arithmetic processing unit, such as a CPU 20 that controls a flat keyboard 5.

The foregoing description has been directed to various embodiments illustrated in the drawings. The scope of the various embodiments, however, is not limited to the illustrated embodiments, and may, of course, employ any known configuration as long as the advantages of the various embodiments can be obtained. Furthermore, the flow of the user feedback method described in the above embodiment is merely an example, and an unnecessary block may be deleted, a new block may be added, and/or a processing order may be changed without departing from the spirit of the method.

What is claimed is:

1. An apparatus, comprising:
a processor of an information handling device; and
a memory that stores code executable by the processor to:
detect an input mechanism contacting a key area for displaying a flat keyboard, and
emit a first sensory feedback to a user in response to detecting the input mechanism contacting the key.

2. The apparatus of claim 1, wherein the first sensory feedback is one of a tactile feedback and an auditory feedback.

3. The apparatus of claim 2, wherein:
the tactile feedback comprises a vibration; and
the auditory feedback comprises a keying sound.

4. The apparatus of claim 3, wherein:
the vibration simulates one of tactilely pressing, tactilely releasing, and both tactilely pressing and tactilely releasing a key on a physical keyboard in the key area; and
the keying sound simulates one of audibly pressing, audibly releasing, and both audibly pressing and audibly releasing the key on the physical keyboard in the key area.

5. The apparatus of claim 1, wherein:
the code is further executable by the processor to emit a second sensory feedback to the user in response to detecting the input mechanism contacting the key; and
the first sensory feedback and the second sensory feedback are different types of sensory feedbacks.

6. The apparatus of claim 5, wherein:
the first sensory feedback is a tactile feedback; and
the second sensory feedback is an auditory feedback.

7. The apparatus of claim 6, wherein:
the tactile feedback comprises a vibration; and
the auditory feedback comprises a keying sound.

8. The apparatus of claim 7, wherein:
the vibration simulates one of tactilely pressing, tactilely releasing, and both tactilely pressing and tactilely releasing a key on a physical keyboard in the key area; and
the keying sound simulates one of audibly pressing, audibly releasing, and both audibly pressing and audibly releasing the key on the physical keyboard in the key area.

9. The apparatus of claim 5, wherein:
the first sensory feedback is emitted at a first time; and
the first sensory feedback is emitted at a first time.

10. The apparatus of claim 9, wherein one of:
the first time and the second time are a same time;
the first time occurs prior to the second time; and
the first time occurs subsequent to the second time.

11. The apparatus of claim 10, wherein:
the first sensory feedback is a tactile feedback; and
the second sensory feedback is an auditory feedback.

12. The apparatus of claim 11, wherein:
the tactile feedback comprises a vibration;
the auditory feedback comprises a keying sound;
the vibration simulates one of tactilely pressing, tactilely releasing, and both tactilely pressing and tactilely releasing a key on a physical keyboard in the key area; and
the keying sound simulates one of audibly pressing, audibly releasing, and both audibly pressing and audibly releasing the key on the physical keyboard in the key area.

13. A method, comprising:
detecting, by use of a processor, an input mechanism contacting a key area for displaying a flat keyboard; and
emitting a first sensory feedback to a user in response to detecting the input mechanism contacting the key.

14. The method of claim 13, further comprising:
emitting a second sensory feedback to a user in response to detecting the input mechanism contacting the key, wherein:
the first sensory feedback and the second sensory feedback are different types of sensory feedbacks.

15. The method of claim 14, wherein:
the first sensory feedback is emitted at a first time and the second sensory feedback is emitted at a second time; and
wherein one of:
the first time and the second time are a same time,
the first time occurs prior to the second time, and
the first time occurs subsequent to the second time.

16. The method of claim 15, wherein:
the first sensory feedback simulates one of tactilely pressing, tactilely releasing, and both tactilely pressing and tactilely releasing a key on a physical keyboard in the key area; and
the second sensory feedback simulates one of audibly pressing, audibly releasing, and both audibly pressing and audibly releasing the key on the physical keyboard in the key area.

17. A program product comprising a computer-readable storage medium that stores code executable by a processor, the executable code comprising code to perform:
detecting, by use of a processor, an input mechanism contacting a key area for displaying a flat keyboard; and
emitting a first sensory feedback to a user in response to detecting the input mechanism contacting the key.

18. The program product of claim 17, wherein the executable code further comprises code to perform:
emitting a second sensory feedback to a user in response to detecting the input mechanism contacting the key, wherein:
the first sensory feedback and the second sensory feedback are different types of sensory feedbacks.

19. The program product of claim 18, wherein:
the first sensory feedback is emitted at a first time and the second sensory feedback is emitted at a second time; and
wherein one of:
the first time and the second time are a same time,
the first time occurs prior to the second time, and
the first time occurs subsequent to the second time.

20. The program product of claim 19, wherein:
the first sensory feedback simulates one of tactilely pressing, tactilely releasing, and both tactilely pressing and tactilely releasing a key on a physical keyboard in the key area; and
the second sensory feedback simulates one of audibly pressing, audibly releasing, and both audibly pressing and audibly releasing the key on the physical keyboard in the key area.
